(19) United States
(12) Patent Application Publication
(10) Pub. No.: US 2024/0428472 A1
(43) Pub. Date: Dec. 26, 2024

(54) SYSTEM AND METHOD FOR AUTOMATICALLY GENERATING GUIDING AR LANDMARKS FOR PERFORMING MAINTENANCE OPERATIONS

(71) Applicant: B.G. Negev Technologies Ltd, at Ben-Gurion University, Beer Sheva (IL)

(72) Inventor: Jihad El-Sana, Lakia (IL)

(21) Appl. No.: 18/704,335

(22) PCT Filed: Oct. 26, 2022
(86) PCT No.: PCT/IL2022/051128

§ 371 Date: Apr. 24, 2024

Related U.S. Application Data
(60) Provisional application No. 63/271,726, filed on Oct. 26, 2021.

(51) Int. Cl. G06T 11/00; G06Q 10/20; G06V 10/82; G06V 20/20; G06V 20/40; G06V 40/20; G09B 5/06

(52) U.S. Cl. CPC G06T 11/00; G06Q 10/20; G06V 10/82; G06V 20/20; G06V 20/41; G06V 40/28; G09B 5/065

(57) ABSTRACT

System for automatically generating AR landmarks for guiding a novice user while performing maintenance operations in a device, such as a mechanical or electronic device. The system comprises one or more video cameras are used to acquire video segments of a sequence of maintenance phases, a computer (with a least one processor) that runs an operation software, for training a Machine Learning (ML) model to identify and classify predetermined parts of the device, tools for performing the maintenance operations by manipulating the state of the parts, manual operations (such as hand gestures) of a professional worker, while using the tools, during manipulation according to a workflow being a sequence of phases for carrying out the maintenance operations. Each phase is a predetermined plurality of corresponding operations performed by the professional worker in any order, to be completed before moving to the next phase. The video segments are processed by the processor and operating software to automatically generate an interaction file using the trained model. The interaction file is adapted to encode the workflow in the form of a collection of landmarks, manual operations, and the relation between them, using a playable format; associate each landmark with a corresponding phase; determine starting and ending landmarks for each phase and determine transitions between completed phases and their corresponding consecutive phases. A player is used to play the interaction file in AR user interface that is worn by the novice user. The player generates graphical guiding visual signs and animations representing each of the phases and transitions, optionally generates audio guiding instructions to be played with corresponding visual signs and animations and adds the graphical guiding visual signs and animations (along with the optional audio guiding instructions) to the AR user interface.

### FIELD OF THE INVENTION

The present invention relates to the field of Augmented Reality (AR). More particularly, the present invention relates to a system and method for automatically generating AR landmarks for guiding a novice user while performing maintenance operations.

### BACKGROUND OF THE INVENTION

Mechanical and electrical devices (such as home appliances, cars, airplanes, machines, industrial systems, and up to power plants) are an integral part of modern daily life. These devices are subject to failures and require regular maintenance, which often necessitates professional workers and technicians. However, the relatively low number of available professional workers and technicians increases the cost of maintenance and repair and introduces a delay until an unskilled user gets the repair service or a less experienced technician manages to complete a maintenance task.

Several conventional guiding methods use mixed reality, virtual reality or Augmented Reality (AR) interfaces for manipulating machines. These methods release users from the need to carry user manuals during their maintenance or repair work and display work instructions on the work environment in the real worldview. However, these methods are mostly used in the high-end industries (businesses that make or sell relatively expensive products, such as vehicle and aircraft industries), since they address expert users, assume clear and well-defined environments and settings, and follow pre-defined workflows. Such pre-defined workflows are expensive to produce since they require a deep understanding of the repair process (i.e., skilled engineers) and involve the generation of guiding illustrations and animations that are manually made by artists and are added to virtual reality environments and interfaces. As a result, low-end enterprises (such as small businesses, garages and repair workshops) could not use AR as an available and affordable guiding means.

It is therefore an object of the present invention to provide a system and method for guiding a novice user to disassemble and assemble devices using automatically generated workflows.

It is another object of the present invention to provide a system and method for guiding a novice user to disassemble and assemble devices that can simply be added to any AR user interface.

It is a further object of the present invention to provide a system and method for guiding a novice user to disassemble and assemble devices that do not require a deep understanding of the repair process or manually generating illustrations and animations.

Other objects and advantages of the invention will become apparent as the description proceeds.

### SUMMARY OF THE INVENTION

A method for automatically generating AR landmarks for guiding a novice user while performing maintenance operations in a device, comprising:
a) training a Machine Learning (ML) model to identify and classify:
   a.1) predetermined parts of the device;
   a.2) tools for performing the maintenance operations by manipulating the state of the parts;
   a.3) hands gestures and manual operations of a professional worker and the novice user during playing the interaction file, while using the tools, during manipulation according to a workflow being a sequence of phases for carrying out the maintenance operations, each phase being a predetermined plurality of corresponding operations performed by the professional worker in any order, to be completed before moving to the next phase;
b) acquiring, by one or more video cameras, video segments of the sequence of maintenance phases;
c) processing the video segments by a processor and operating software and automatically generating, by the processor and operating software, using the trained model, an interaction file, which could be represented using a JavaScript Object Notation (JSON) file or an Extensible Markup Language (XML) file, which is adapted to:
   c.1) encode, using a playable format, the workflow in the form of a collection of landmarks, manual operations, and the relation between them;
   c.2) associate each landmark with a corresponding phase;
   c.3) determine starting and ending landmarks for each phase;
   c.4) determine transitions between completed phases and their corresponding consecutive phases;
d) playing the interaction file by a player, which is adapted to:
   d.1) generate graphical guiding visual signs and animations representing each of the phases and transitions;
   d.2) generate audio guiding instructions to be played with corresponding visual signs and animations;
e) add the graphical guiding visual signs and animations and the audio guiding instructions to the AR user interface (such as a smart helmet or smart glasses with AR capability), to be worn by the novice user.

The camera may be a body camera that is attached to the forehead of the professional worker.

The processing of the video segments may comprise:
a) detecting and recognizing, the operations carried out by the professional worker;
b) recognizing and tracking the manipulated parts of the device;
c) detecting the order of the operations carried out by the professional worker and grouping together several operations into a sequence;
d) detecting work scenes performed by the professional worker during each phase.

Voice indications may be integrated into the generated and/or the played interaction file, for guiding the user via the AR interface.

The operations within each phase may be performed by the professional worker or by the novice user according to any order.

The interaction file may be played according to the following steps:
a) arranging the workflow according to progress in the workflow steps and termination points;
b) detecting the work scene and the target parts at each step;
c) drawing markers on the scene, to guide the novice user while carrying out the workflow operations;
d) performing a validation process by the operating software of the AR interface device, to ensure that any operation was completed successfully according to the workflow
wherein progress in playing said interaction file is made according to said workflow and the transition from a phase to the next phase is done upon detecting that all the mandatory operations in a current phase have been completed by the user.

Voice indications may be integrated into the played AR, for guiding the user.

Whenever a CAD model of a real object or part exists, said CAD model is registered with the real object according to the following steps:
a) determining the viewing transformation for a specific part to be rendered into a corresponding specific image, using deep learning;
b) using at least a body-mounted camera and a side view camera, where each view includes moving hands and moving parts and objects in the viewed environment.
c) Performing multi-view tracking occlusion and identification of changes in the viewed environment, resulting from manipulating objects and parts;
d) sampling the views from a surface of a sphere bounding each part;
e) measured the distance between these views and the input image;
f) refining each view by adding more views from the same area and repeating refinement until obtaining convergence;
g) computing viewing transformation based on the homography transformation between the best view and the input image;
h) detecting and recognizing hand gestures and manual operations performed by the professional worker on mechanical parts/objects in each video segment;
i) defining a set of manual operations in order to train a deep learning model, to detect and classify the performed operations across consecutive frames; and
j) detecting phase transitions, based on the difference between consecutive views.

The viewing transformation may be the camera position and angle of view.

The deep learning may be based on Siamese Neural Network and Feature Pyramid Network for detecting lines and contour boundaries.

A system for automatically generating AR landmarks for guiding a novice user while performing maintenance operations in a device, comprising:
a) acquiring, by one or more video cameras, video segments of a sequence of maintenance phases;
b) a computer with a least one processor running an operation software, for training a Machine Learning (ML) model to identify and classify:
   a.1) predetermined parts of the device;
   a.2) tools for performing the maintenance operations by manipulating the state of the parts;
   a.3) manual operations (such as hand gestures) of a professional worker, while using the tools, during manipulation according to a workflow being a sequence of phases for carrying out the maintenance operations, each phase being a predetermined plurality of corresponding operations performed by the professional worker in any order, to be completed before moving to the next phase;
c) processing the video segments by the processor and operating software and automatically generating, by the processor and operating software, using the trained model, an interaction file which is adapted to:
   c.1) encode, using a playable format, the workflow in the form of a collection of landmarks, manual operations, and the relation between them;
   c.2) associate each landmark with a corresponding phase;
   c.3) determine starting and ending landmarks for each phase;
   c.4) determine transitions between completed phases and their corresponding consecutive phases;
d) an AR user interface, to be worn by the novice user;
e) a player for playing the interaction file, which is adapted to:
   d.1) generate graphical guiding visual signs and animations representing each of the phases and transitions;
   d.2) generate audio guiding instructions to be played with corresponding visual signs and animations;
f) add the graphical guiding visual signs and animations and the audio guiding instructions to the AR user interface.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1A schematically illustrates a disassembly phase, performed by a professional worker;

FIG. 1B schematically illustrates an assembly phase, performed by a professional worker;

FIG. 2A-2B schematically illustrates markers that are displayed to a novice user who wears an appropriate AR interface device, during assembly and disassembly phases; and

FIG. 3 schematically illustrates a graph that represents the workflow sequence of phases, derived from the interaction file, according to an embodiment of the invention.

### DETAILED DESCRIPTION OF THE PRESENT INVENTION

The present invention proposes a system and method for guiding a novice user to disassemble and assemble devices using automatically generated workflows, based on the processing of video footage. The generated workflows can be added to any AR user interface that can be worn by the user and does not require a deep understanding of the repair process or manually generating illustrations and animations.

The present invention uses Machine Learning (ML) techniques to train a model that learns manual operations performed by a professional worker (such as a skilled technician or an engineer) according to a determined workflow. One or more cameras are used to record footages of the professional worker from various angles, while carrying out the various steps and different operations from the determined workflow. For example, a camera may be a GoPro body camera (of GoPro Inc., San Mateo, CA, U.S.A.) that is attached to the forehead of the professional worker. Other video cameras may be added to obtain improved accuracy for identifying operations performed by the professional worker.

The system automatically generates AR landmarks for guiding a novice user while performing maintenance operations in a device, such as a mechanical or electronic device. Accordingly, one or more video cameras are used to acquire video segments of a sequence of maintenance phases. The system comprises a computer (with a least one processor) that runs an operation software, for training a Machine Learning (ML) model to identify and classify predetermined parts of the device, tools for performing the maintenance operations by manipulating the state of the parts, manual operations (such as hand gestures) of a professional worker, while using the tools, during manipulation according to a workflow being a sequence of phases for carrying out the maintenance operations, each phase being a predetermined plurality of corresponding operations performed by the professional worker in any order, to be completed before moving to the next phase. The video segments are processed by the processor and operating software to automatically generate an interaction file using the trained model. The interaction file is adapted to encode the workflow in the form of a collection of landmarks, manual operations, and the relation between them, using a playable format; associate each landmark with a corresponding phase; determine starting and ending landmarks for each phase and determine transitions between completed phases and their corresponding consecutive phases. A player is used to play the interaction file in AR user interface that is worn by the novice user. The player is adapted to generate graphical guiding visual signs and animations representing each of the phases and transitions, optionally generate audio guiding instructions to be played with corresponding visual signs and animations and to add the graphical guiding visual signs and animations (along with the optional audio guiding instructions) to the AR user interface.

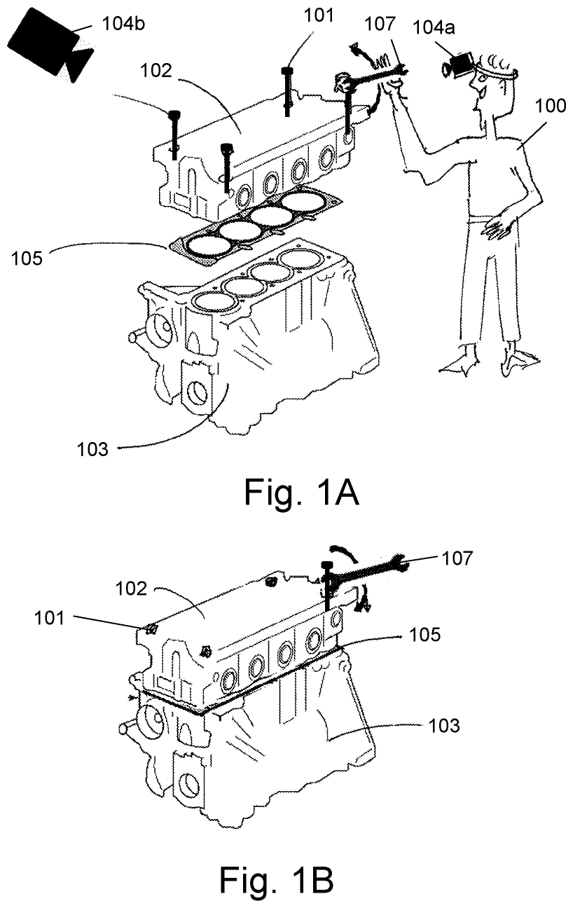

For example, if the professional worker should guide a novice user on how to replace an engine head gasket 105, this operation involves a workflow w with the following three consecutive phases, as shown in FIG. 1A:

At the first phase, the professional worker 100 disassembles (or more generally, manipulates the state of) the four screws 101 and removes the cover 102 from the engine block 103. The cameras 104a and 104b follow the movements of his hands while disassembling each screw 101, in order to identify the screws, the engine head 102, the engine block 103 and the manual operations performed until he completed the disassembly of all four screws 101. The cameras also identify the tool he used for the disassembly—in this example, an open-ended wrench 107, which during disassembly, is turned by his hands in a counterclockwise direction, to thereby turn the screws 101, as well. As long as he did not complete the disassembly of all four screws, the workflow will not continue to the next phase. The disassembly order in this example is not important, but in other cases may be important.

At the second phase (FIG. 1B), the professional worker 100 disassembles and removes the engine head 102, removes the old gasket 105 and puts a new gasket in place (on the engine block 103). The cameras 104a and 104b follow the movements of his hands while removing the engine head (by hands) and the old gasket, in order to identify when he completed the removal. The cameras 104a and 104b also identify the tool he used for the disassembly—in this example, a trowel (not shown), which during disassembly, is moved in opposite directions to peel away remainders of the old gasket. As long as he did not complete peeling away the old gasket, the workflow will not continue to the next phase.

At the third phase, the professional worker reassembles the four screws 101 to obtain a sufficient seal. The cameras 104a and 104b follow the movements of his hands while reassembling the engine head 102 and tightening each screw 101, in order to identify when he completed the reassembly of all four screws 101. The cameras 104a and 104b also identify the tool he used for the disassembly—in this example, his hands for putting back the engine head in place and the same open-ended wrench 107, which during reassembly, is turned by his hands in the clockwise direction, to thereby turn the screws 101, as well. As long as he did not complete the reassembly of all four screws 101, the workflow will not continue to the next phase. The reassembly order in this example is not important, but in other cases may be important.

The acquired video segments (taken from each video footage) are processed to generate an Interaction File, which encodes the steps and the operation carried out by the professional worker along all phases and is then used to guide a novice user to carry out the same workflow w. The generated interaction file is not the recorded video clip, but a compact collection of workflow landmarks, manual operations, and the relation between them.

First, the device and the viewed scene are detect and the device is registered (image registration is the process of transforming different sets of data into one coordinate system) with a Computer-Aided Design (CAD—also known as 3D Modelling, allows designers to test, refine and manipulate virtual products prior to production) model, if exists.

The generation of the Interaction File comprises the following steps: At the first step, the operations carried out by the professional worker are detected and recognized. At the next step, the manipulated parts of the device are recognized and being tracked. At the next step, the order of the operations carried out by the professional worker is detected and several operations are grouped together to a sequence. At the next step, changes in the work scenes performed by the professional worker are detected.

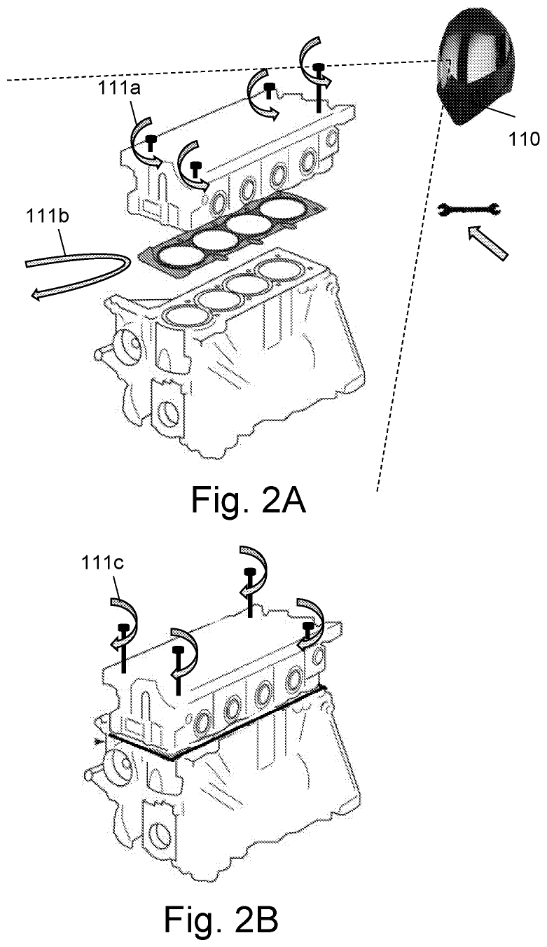

After generating the Interaction File, this file is played to a novice user who wears an appropriate AR interface device 110, such as Jarvish X smart helmet (Jarvish Inc., Taiwan) or any type of smart glasses with AR capability, as shown in FIGS. 2A-2B. The file is played according to the following steps: At the first step, the workflow is arranged according to progress in the workflow steps and termination points. At the next step, the work scene and the target parts at each step are detected. At the next step, markers (such as 111a to unscrew, 111b to replace and 111c to screw) are drawn on the scene, to guide the novice user while carrying out the workflow operations. At the next step, the operating software of the AR interface device performs a validation process, to ensure that any operation was completed successfully according to the workflow.

These tasks are carried out by an Interaction Generator, and an Interaction Player, which will be described.

The Interaction Generator tracks the professional worker while performing a workflow and automatically generates, from video segments of the video footage, the Interaction File, which may be, for example, a JavaScript Object Notation (JSON) file (The JSON format is syntactically similar to the code for creating JavaScript objects and therefore, a JavaScript program can easily convert JSON data into JavaScript objects. Since the format is text only, JSON data can easily be sent between computers, and used by any programming language), or an Extensible Markup Language (XML) file (the XML standard is a flexible way to create information formats and electronically share structured data via the public internet, as well as via corporate networks).

The following process is performed by the system provided by the present invention:

The first stage determines the viewing transformation (camera position and angle of view) for a specific part (e.g., a mechanical part), which renders into a corresponding specific image. A deep learning architecture is used to determine the viewing transformation. This deep learning architecture is based, for example, on the Siamese Neural Network (SNN—an artificial neural network that uses the same weights while working in tandem on two different input vectors to compute comparable output vectors) and Feature Pyramid Network (FPN—a feature extractor for object recognition, that takes a single-scale image of arbitrary size as input, and outputs proportionally sized feature maps at multiple levels, in a fully convolutional fashion) as the branch basic architecture (of course, other advanced ML models can be used by a person skilled in the art). The feature FPN has a good ability to learn to detect lines and contour boundaries, which are among the main features of mechanical objects' images.

The second stage includes multi-view tracking (occlusion and identification of changes in the viewed environment), as a result of taking off and putting on mechanical parts, and of the interaction of the professional worker's hands with these parts. The views from a surface of a sphere bounding the object are sampled and the distance between these views and the input image, is measured. Then, the closed view is refined by adding more views from that area. This refinement procedure is repeated until obtaining convergence. According to another embodiment, an ML model that learns the view direction of devices and parts from their CAD models may be used.

Then the homography (an isomorphism of projective spaces, induced by an isomorphism of the vector spaces from which the projective spaces derive) transformation (any two images of the same planar surface in space are related by a homography. This has many practical applications, such as image rectification, image registration, or camera motion-rotation and translation-between two images) between the best view and the input image is computed, in order to compute the viewing transformation. In a typical embodiment, at least a body-mounted camera and a side view camera are utilized, where the two video streams are analyzed in a synchronized manner. Each view includes moving hands and moving mechanical objects with a high level of occlusion and drastic changes in the viewed environment. Complex scenes may be processed by combining semantic segmentation, object detection/recognition, and the CAD tree within the tracking algorithm.

The third stage includes detecting and recognizing hand gestures and manual operations performed by the professional worker (i.e., the movements of his hands) on mechanical parts in each video segment. Accordingly, a set of manual operations is defined in order to train a deep learning model, to detect and classify these operations. Hand gestures, object recognition, and objects' viewing transformation is utilized to generate semantic entities, which are fed to a Recurrent Neural Network (RNN) model (a class of artificial neural networks where connections between nodes can create a cycle, allowing output from some nodes to affect subsequent input to the same nodes), to utilize the temporal relations among these entities, across consecutive frames.

The fourth stage includes detecting phase transitions, where each phase transition marks the completion of a phase and the start of a new phase. The phase structure may include features of representative views of the phase, to synchronize the progress of the phase with the actual working area. Phase transition is detected based on the difference between consecutive views (not frames), the visibility of manipulated items and their work area, and the CAD tree, if exists. For example, removing a cover or a large part, p, will expose a new region, but this will mark a phase transition only if the following operations are applied to the area, which was occluded by p.

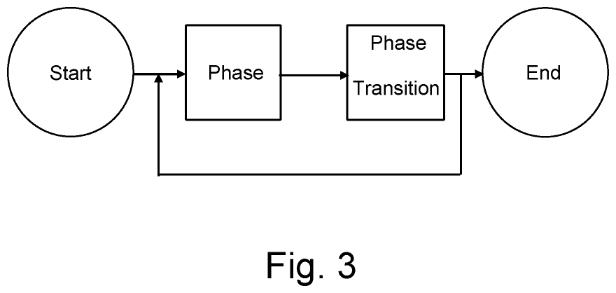

The Interaction file may be represented as a graph that represents the workflow steps. It consists of the start state and sequence of phases, which are separated by phase transitions, as shown in FIG. 3.

A phase is a sequence of operations, which must be completed before completing the phase and moving to the next phase. These operations may or may not be carried out in a specific order. Each operation structure includes one or more of the following: the region, the tool, the manipulated item (a part or a component), and the operation name. A phase transition marks completing a phase and starting a new one. In addition, the phase structure may include features of representative views of the phase to synchronize the progress of the phase with the actual work.

The Interaction Player receives the interaction file and plays it along with audio instructions that may be added, to guide a novice user to apply the same workflow (that has been encoded in the Interaction File), under similar circumstances. Interaction Player performs tracking, object recognition, phase transition detection and operation detection, to appropriately mark the operation region and provide illustrations for the various manual operations. The Interaction Player also determines when a phase is completed and the timing to move to the next phase. The played guiding information is displayed by playing the Interaction File on an AR interface of the novice user.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

1. A method for automatically generating AR landmarks for guiding a novice user while performing maintenance operations in a device, comprising:
a) training a Machine Learning (ML) model to identify and classify:
a.1) predetermined parts of said device;
a.2) tools for performing said maintenance operations by manipulating the state of said parts;
a.3) hands gestures and manual operations of a professional worker, while using said tools, during manipulation according to a workflow being a sequence of phases for carrying out said maintenance operations, each phase being a predetermined plurality of corresponding operations performed by said professional worker in any order, to be completed before moving to the next phase;
b) acquiring, by one or more video cameras, video segments of said sequence of maintenance phases;
c) processing said video segments by a processor and operating software and automatically generating, by said processor and operating software, using the trained model, an interaction file which is adapted to:
c.1) encode, using a playable format, said workflow in the form of a collection of landmarks, manual operations, and the relation between them;
c.2) associate each landmark with a corresponding phase;
c.3) determine starting and ending landmarks for each phase;
c.4) determine transitions between completed phases and their corresponding consecutive phases;
d) playing said interaction file by a player, which is adapted to:
d.1) generate graphical guiding visual signs and animations representing each of said phases and transitions;
d.2) generate audio guiding instructions to be played with corresponding visual signs and animations;
e) add said graphical guiding visual signs and animations and the audio guiding instructions to an AR user interface, to be worn by said novice user.

2. A method according to claim 1, wherein the camera is a body camera attached to the forehead of the professional worker.

3. A method according to claim 1, wherein the processing of the video segments comprises:
a) detecting and recognizing, the operations carried-out by the professional worker;
b) recognizing and tracking the manipulated parts of the device;
c) detecting the order of the operations carried-out by the professional worker and grouping together several operations into a sequence;
d) detecting portions of the work scenes that are performed by the professional worker during each phase.

4. A method according to claim 1, further comprising integrating voice indications to the generated and/or to the played interaction file, for guiding the user via the AR interface.

5. A method according to claim 1, wherein the operations within each phase are performed by the professional worker or by the novice user, according to any order.

6. A method according to claim 1, wherein the AR user interface is a smart helmet or smart glasses with AR capability.

7. A method according to claim 1, wherein the interaction file is played according to the following steps:
a) arranging the workflow according to progress in the workflow steps and termination points;
b) detecting the work scene and the target parts at each step;
c) drawing markers on the scene, to guide the novice user while carrying out the workflow operations; and
d) performing a validation process by the operating software of the AR interface device, to ensure that any operation was completed successfully according to the workflow,
wherein progress in playing said interaction file is made according to said workflow and the transition from a phase to the next phase is done upon detecting that all the mandatory operations in a current phase have been completed by the user.

8. A method according to claim 1, wherein the Interaction File is a JavaScript Object Notation (JSON) file or an Extensible Markup Language (XML) file.

9. A method according to claim 1, further comprising integrating voice indications into the played AR, for guiding the user.

10. (canceled)

11. A method according to claim 1, wherein the operations within each phase are performed by the professional worker or by the novice user according to any order.

12. A method according to claim 1, wherein whenever a CAD model of a real object or part exists, said CAD model is registered with the real object according to the following steps:
a) determining the viewing transformation for a specific part to be rendered into a corresponding specific image, using deep learning;
b) using at least a body-mounted camera and a side view camera, where each view includes moving hands and moving parts and objects in the viewed environment.
c) Performing multi-view tracking occlusion and identification of changes in the viewed environment, resulting from manipulating objects and parts;
d) sampling the views from a surface of a sphere bounding each part;
e) measured the distance between these views and the input image;
f) using the ML and the CAD models to register the part within the view by refining each view by adding more views from the same area and repeating refinement until obtaining convergence;
g) computing viewing transformation based on the homography transformation between the best view and the input image;
h) detecting and recognizing hand gestures and manual operations performed by the professional worker on mechanical parts/objects in each video segment;
i) defining a set of manual operations in order to train a deep learning model, to detect and classify the performed operations across consecutive frames; and
j) detecting phase transitions, based on the difference between consecutive views.

13. A method according to claim 12, wherein the viewing transformation is the camera position and angle of view.

14. A method according to claim 12, wherein the deep learning is based on Siamese Neural Network and Feature Pyramid Network for detecting lines and contour boundaries.

15. A system for automatically generating AR landmarks for guiding a novice user while performing maintenance operations in a device, comprising:
a) acquiring, by one or more video cameras, video segments of a sequence of maintenance phases;
b) a computer with a least one processor running an operation software, for training a Machine Learning (ML) model to identify and classify:
a.1) predetermined parts of said device;
a.2) tools for performing said maintenance operations by manipulating the state of said parts;
a.3) hand gestures of a professional worker, while using said tools, during manipulation according to a workflow being a sequence of phases for carrying out said maintenance operations, each phase being a predetermined plurality of corresponding operations performed by said professional worker in any order, to be completed before moving to the next phase;
c) processing said video segments by said processor and operating software and automatically generating, by said processor and operating software, using the trained model, an interaction file which is adapted to:
c.1) encode, using a playable format, said workflow in the form of a collection of landmarks, manual operations, and the relation between them;
c.2) associate each landmark with a corresponding phase;
c.3) determine starting and ending landmarks for each phase;
c.4) determine transitions between completed phases and their corresponding consecutive phases;
d) an AR user interface, to be worn by said novice user; and
e) a player for playing said interaction file, which is adapted to:
d.1) generate graphical guiding visual signs and animations representing each of said phases and transitions;
d.2) generate audio guiding instructions to be played with corresponding visual signs and animations;
f) add the graphical guiding visual signs and animations and the audio guiding instructions to the AR user interface.
